(19) United States
(12) Patent Application Publication
(10) Pub. No.: US 2019/0383162 A1
(43) Pub. Date: Dec. 19, 2019

(54) Burst Protection Device For A Gas Turbomachine

(71) Applicant: MAN Energy Solutions SE, Augsburg (DE)

(72) Inventors: Stefan WEIHARD, Augsburg (DE); Steffen BRAUN, Augsburg (DE); Harald DENKEL, Baar (DE); Bernd HAAS, Neusass (DE); Johannes NIEBUHR, Augsburg (DE); Urban SPATZ, Neusass (DE); Daniel ALBRECHT, Augsburg (DE)

(73) Assignee: MAN Energy Solutions SE

(21) Appl. No.: 16/428,568

(22) Filed: May 31, 2019

(30) Foreign Application Priority Data
Jun. 13, 2018 (DE) DE102018114093.2

(51) Int. Cl. F01D 21/04; F02B 39/16; F01D 25/30

(52) U.S. Cl. CPC F01D 21/045; F02B 39/16; F05D 2240/14; F05D 2220/40; F01D 25/30

(57) ABSTRACT

A burst protection device for a gas turbomachine formed of at least one pipe section of a pipe in the form of a bend segment of the pipe section for assembly about a turbine wheel housing and/or compressor housing of the gas turbomachine. The bend segment of the pipe section seen in the circumferential direction of the pipe has an interruption for the gas or air outlet of the turbine wheel housing or compressor housing.

### BACKGROUND OF THE INVENTION

### 1. Field of the Invention

The invention relates to a burst protection device for a gas turbomachine, to an internal combustion engine having such a gas turbomachine, and to a gas turbomachine having such a burst protection device.

### 2. Description of the Related Art

A turbocharger, also called exhaust gas turbocharger (ATL) or colloquially turbo, is an optional assembly of an internal combustion engine and serves for increasing the performance or efficiency.

An exhaust gas turbocharger consists of a compressor and a turbine, which are connected to one another by a common shaft. Driven by the exhaust gases of the internal combustion engine, the turbine supplies the drive energy for the compressor. For turbochargers, radial compressors and centripetal turbines are employed in most cases.

The basic principle consists in utilizing a part of the energy of the engine exhaust gas to increase the pressure in the intake system and thereby deliver more outside air into the cylinder than with a naturally aspirated engine, which results in an increase of the efficiency. Thus, turbochargers can utilize the pressure (ram induction) and the motion energy of the exhaust gases (pulse turbocharging). With an additional charge air cooler a higher working pressure with the same temperature can be achieved in the cylinder.

Conceptually, the compressor and the turbine comprise an air conducting spiral that in the turbine serves for conducting the exhaust gases and in the compressor for transporting the inducted air for the engine.

Currently known high-performance turbomachines, such as for example exhaust gas turbochargers of supercharged internal combustion engines constitute a high risk for the surroundings of the turbocharger in the case of a technical failure of the rotating parts of the same. Particularly during the operation in situations where persons are present in the immediate surroundings of the turbomachine it has to be ensured that in the event of a failure, i.e. during a bursting, all parts are securely and completely intercepted and cannot injure any person.

In order to prevent fragments striking through the outer wall of the turbocharger thus endangering persons or damaging neighboring machine components, the turbochargers were provided with relatively thick walls in the turbine housing in the region radially outside the turbine impeller. However, these solutions have a number of disadvantages such as the substantial additional weight of the housing and the risk of shrink hole formation because of poor castability of such a turbine housing. In addition, a housing increased in thickness in such a manner heats up differently which can result in thermal cracks.

From DE 42 23 496 A1 a device for reducing the kinetic energy of bursting parts for machines rotating with high speed is known. This device arranged in the interior of an axial turbine consists of multiple protective rings that are connected to one another, between which in each case a crumble zone produced from a ductile material is formed. However, such a solution is not suitable for radial turbines since, because of the radial gas inlet of the same, no burst protection devices can be employed in the radial region of the turbine.

From U.S. Pat. No. 4,875,837 a multi-layer burst protection is known, in which a heat-insulating material is introduced into an iron plate that is attached at a distance from a turbine housing and to a spiral part of the turbine housing. Disadvantageous in the burst protection described there however is the circumstance that this burst protection only surrounds a 120° angular range of the spiral part of the housing and is thus formed partly open.

From DE 196 40 654 A1 a further burst protection is known, which is provided outside a gas inlet housing of a radial turbine for a turbocharger, which is formed as a spiral sheet metal cover and is detachably connected to the gas inlet housing by way of multiple screws.

Furthermore, solutions are known in which bent metal sheets are arranged about the spiral as burst protection but which are of a simple design in order to reduce the manufacturing costs, but which only have a limited strength and stiffness and which with regard to the behavior as reaction to the natural frequencies that occur during the operation also have an unfavorable characteristic.

### SUMMARY OF THE INVENTION

It is therefore the object of one aspect of the present invention to avoid said disadvantages and create an improved secure burst protection device for radial turbines of turbochargers that is simple to produce and thus further improve the safety of turbochargers, wherein disadvantageous effects due to the natural frequencies that occur during the operation are to be reduced.

A basic idea of one aspect of the invention consists in forming a burst protection device having one or more pipe sections arranged in layers which in each case is formed round about the spiral of the turbine and/or of the compressor. According to one aspect of the invention, a conventional pipe is used for this purpose, from which a pipe segment in the desired width is cut off and cut open in the position for the gas outlet or air outlet, so that a bend segment is obtained.

It is advantageous, furthermore, when the pipe section of the pipe is in the form of a bend segment. In a preferred configuration of one aspect of the invention it is provided that the bend segment out of the pipe section consists of approximately ¾ of the circumference of the pipe or the bend segment of the pipe section forms a bend of approximately 260° to 280°.

For the assembly about a turbine impeller housing and/or compressor housing of a gas turbomachine, in particular radial gas turbomachine the pipe section is configured so that the bend segment of the pipe section seen in the circumferential direction of the pipe has an interruption for the gas or air outlet of the turbine wheel housing or compressor housing.

It is particularly advantageous when at least one end of the bend segment of the pipe section forms a section that is not bent but extends flat. By way of this, the burst protection can also be run up tightly against the gas or air outlet of the turbine wheel housing or compressor housing.

Further advantageous is an embodiment in which one or more cables, preferentially metallic wire cables are run along the outer shell of the bend segment of the pipe section and attached to the pipe section. Here, two or more metal cables running parallel can be stretched about the outer shell for example so that through the additional bracing by the cables a reduction of the wall thicknesses of the pipe components is possible, since the cables reduce the risk of the bursting of the pipe section i.e. of the burst protection formed out of the pipe section. Large components are thereby additionally prevented from escaping radially.

In a further preferred configuration of the invention it is provided that the cables are attached to the pipe section by cable tensioning elements to be able to adjust the tension of the cables. It is preferred, furthermore, when the cables are attached to the pipe section by spring elements. Because of such spring elements, the pipe sections can be embodied with thinner wall thicknesses and if applicable lower cable diameters since the kinetic energy that occurs in the event of a bursting can be better dissipated by the spring elements in that a kind of “braking action” by the elastic arrangement of the cables counteracts the escaping components.

Holding elements, preferentially webs projecting to the outside, can likewise be advantageously attached to the bend segment of the pipe section, to which the cables are directly or indirectly attached.

In a further advantageous aspect of the invention it is provided that the burst protection device is formed in multiple parts, preferentially consisting of multiple pipe sections arranged in layers on top of one another. By way of such a construction it is possible on the one hand to create a modular solution matched to the application and the individual pipes can have thinner wall thicknesses.

A further aspect of the present invention relates to a gas turbomachine, in particular a radial gas turbomachine, with a burst protection device as described above, which is arranged round about the turbine wheel housing or compressor housing of the gas turbomachine. Obviously, a burst protection device can also be arranged round about each of the turbine wheel housing and of the compressor housing.

In an advantageous configuration of the gas turbomachine it is provided that the turbine wheel housing and/or the compressor housing form a spiral gas duct which on the one side has an exhaust gas feed or an air feed (in the case of the compressor) and the burst protection device engages about the gas duct so that the interruption of the burst protection device provides a passage for the exhaust gas feed or the air feed.

A further aspect of the present invention relates to an internal combustion engine having a gas turbomachine designed in this way.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantageous further developments of the invention are marked in the subclaims and are shown below in more detail by way of the FIGURE together with the description of the preferred embodiment of the invention. It shows:

The FIGURE is a burst protection device according to one aspect of the present invention.

### DETAILED DESCRIPTION OF THE PRESENTLY PREFERRED EMBODIMENTS

In the following, the invention is described in more detail making reference to the FIGURE. In the FIGURE, a perspective view of an exemplary embodiment of a burst protection device 1 is shown in an assembled situation mounted about a turbocharger housing.

Shown is the turbine housing 10 of a gas turbomachine in which, in the operating state, a turbine wheel driven by an exhaust gas flow through the spiral gas duct 11, rotates.

The burst protection device 1 is formed from a pipe section 2 of a pipe in the form of a bend segment of the pipe section 2 and in its assembled position arranged round about the turbine wheel housing 10, wherein the bend segment of the pipe section 2, seen in circumferential direction of the pipe, has an interruption U. By using pipe materials with high elongation at break and notch impact strength, energy is dissipated in an optimized manner with relatively small component sizes, which brings with it weight and cost advantages.

The turbine wheel housing 10, which forms the spiral gas duct 11, comprises on the one side an exhaust gas feed 12, wherein the burst protection device 1 engages about the gas duct 11 in such a manner that the said interruption U provides a passage for the exhaust gas feed 12.

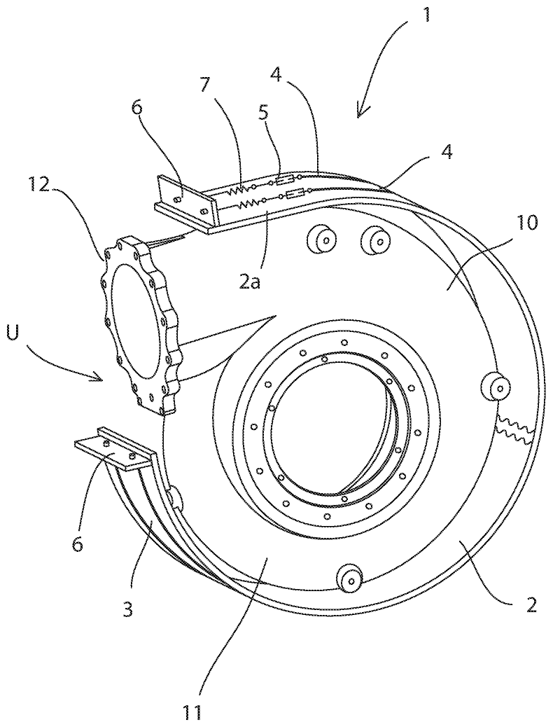

It is evident, furthermore, that the bend segment of the pipe section 2 forms a bend of approximately 270° and the in the FIG. 1 upper end of the bend segment of the pipe section 2 in its extension forms a section 2a that is not bent but extends flat.

Two cables 4, namely metallic wire cables run along the outer shell 3 of the bend segment of the pipe section 2, wherein the cables are each attached to the pipe section 2 at the end side namely to holding elements 6, which at the end side on the bend segment of the pipe section 2 project to the outside. The one holding element 6 is formed on the flat section 2a. The holding elements 6 are each attached as webs projecting to the outside to the outer shell 3 of the pipe section 2 and the cables are directly attached thereto via cable tensioning elements 5 and spring elements 7.

The cable tensioning elements 5 are arranged between the spring element 7 and the respective cable 4 so that the tension of the cables can be adjusted.

The invention, in its embodiment, is not restricted to the preferred exemplary embodiments stated above. On the contrary, a number of versions is conceivable which makes use of the shown solution even with embodiments that are of a fundamentally different type, so that for example the assembly sequence of the cable tensioning elements 5 and spring elements 7 can also be inverse or individual cables can also be attached to the holding means only by way of turnbuckles without spring elements.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A burst protection device comprising:
at least one pipe section of a pipe configured as a bend segment of the at least one pipe section, for mounting about a turbine wheel housing and/or compressor housing of a gas turbomachine; and
an interruption defined by the bend segment of the at least one pipe section seen in a circumferential direction of the pipe and configured for a gas or air outlet of the turbine wheel housing or the compressor housing.

2. The burst protection device according to claim 1, wherein the bend segment of the at least one pipe section forms a bend of approximately 260° to 280°.

3. The burst protection device according to claim 1, wherein at least one end of the bend segment of the at least one pipe section forms a section that is not bent but extends flat.

4. The burst protection device according to claim 1, wherein one or more cables run along an outer shell of the bend segment of the at least one pipe section and are attached to the at least one pipe section.

5. The burst protection device according to claim 4, wherein the one or more cables are attached to the at least one pipe section by cable tensioning elements configured to adjust a tension of the one or more cables.

6. The burst protection device according to claim 4, wherein the one or more cables are attached to the at least one pipe section by respective spring elements.

7. The burst protection device according to claim 4, further comprising:
holding elements attached to respective ends of the bend segment of the at least one pipe section, to which the one or more cables are directly or indirectly attached.

8. The burst protection device according to claim 1, wherein the burst protection device is formed of multiple parts.

9. A gas turbomachine, configured as a radial gas turbomachine, comprising:
at least one of a turbine wheel housing and a compressor housing; and
a burst protection device comprising:
at least one pipe section of a pipe configured as a bend segment of the at least one pipe section, for mounting about at least one of the turbine wheel housing and the compressor housing; and
an interruption defined by the bend segment of the at least one pipe section seen in a circumferential direction of the pipe and configured for a gas or air outlet of the turbine wheel housing or compressor housing.

10. The gas turbomachine according to claim 9, wherein at least one of the turbine wheel housing and the compressor housing forms a spiral gas duct, which on a one side comprises an exhaust gas feed or an air feed and the burst protection device is configured to engage about the spiral gas duct so that the interruption provides a passage for the exhaust gas feed or the air feed.

11. The burst protection device according to claim 1, wherein the gas turbomachine is a radial gas turbomachine.

12. The burst protection device according to claim 4, wherein the one or more cables are metallic wire cables.

13. The burst protection device according to claim 7, wherein the holding elements are configured as webs projecting radially outward.

14. The burst protection device according to claim 8, wherein the multiple parts are multiple pipe sections arranged in layers on top of one another.
